(19) United States
(12) Patent Application Publication
(10) Pub. No.: US 2021/0217190 A1
(43) Pub. Date: Jul. 15, 2021

(54) ANALYZER FOR THREE-DIMENSIONALLY ANALYZING A MEDICAL SAMPLE BY MEANS OF A LIGHT FIELD CAMERA

(71) Applicant: Siemens Healthcare Diagnostics Inc., Tarrytown, NY (US)

(72) Inventors: Thomas Engel, Aalen (DE); Gabriele Hörnig, Fürth (DE); Gaby Marquardt, Hausen (DE); Lukas Richter, Hirschaid (DE)

(21) Appl. No.: 17/059,420

(22) PCT Filed: May 16, 2019
(86) PCT No.: PCT/IB2019/054051

§ 371 Date: Nov. 27, 2020

(30) Foreign Application Priority Data
May 30, 2018 (EP) 18000484.8

(51) Int. Cl. G06T 7/557; G02B 21/36; H04N 5/225; H04N 5/247; G06K 9/00; G06T 11/00; H04N 5/232

(52) U.S. Cl. CPC G06T 7/557; G02B 21/361; H04N 5/22541; H04N 5/2256; H04N 9/04; G06K 9/00147; G06T 11/001; H04N 5/23212; H04N 5/247

(57) ABSTRACT

The invention relates to an analyzer for analyzing a medical sample. The analyzer comprises an optical microscope for imaging a light field in an object region in order to image the sample. The microscope comprises a light source for illuminating the sample, an objective comprising a converging lens for concentrating and focusing light beams coming from the illuminated sample, and a digital recording device for recording the light beams. A light-field camera for capturing the light field from the object region, which light field is imaged in the microscope, is provided on the microscope.

### CROSS REFERENCE TO RELATED APPLICATIONS

This is a 371 of PCT/IB2019/054051, filed May 16, 2019, which claims priority to European Patent Application No. EP 18000484.8, filed May 30, 2018, both of which are hereby incorporated by reference herein in their entireties for all purposes.

### FIELD

The invention lies in the field of automated analyzers and relates to a hematology analyzer for analyzing cells in a sample using a microscopy apparatus with a light field camera.

### BACKGROUND

So-called “automated cell counters” are used with increasing success for the automated analysis of cells. Examples thereof are the Advia 2120, Sysmex XE-2100, CellaVision DM96, and CellaVision DM1200 devices. Apart from their high throughput, these automated devices provide a few advantages, such as high objectivity (no variability depending on the observer), elimination of statistical variations usually linked to a manual count (count of large cell numbers), and the determination of numerous parameters which would not be available in the case of a manual count, as well as, as mentioned, more efficient and cost-effective handling. Some of these devices can work through 120 to 150 patient samples per hour.

The technical principles underlying the automated single cell count are usually based either on an impedance (resistance) measurement or an optical system (scattered light or absorption measurement). Further, imaging systems which automatically image and evaluate the cells of a blood smear, for example, have become established.

In the impedance method, the cells are counted and the sizes thereof are determined on the basis of the detection and the measurement of changes in the electrical conductivity (resistance), which is caused by a particle moving through a small opening. Particles such as blood cells themselves do not conduct but are suspended in an electrically conductive diluent. If such a suspension of cells is guided through an opening, the impedance (resistance) of the electrical path between the two electrodes, which are situated on each side of the opening, briefly increases during the passage of a single individual cell.

In contrast to the impedance method, the optical method comprises the passing of a laser light beam or an LED light beam through a diluted blood sample, which is detected by the laser beam or the LED light beam in a continuous flow. Here, the corresponding light beam can be guided to the flow cell by means of an optical waveguide, for example. Every cell passing through the detection zone of the flow cell scatters the focused light. Then, the scattered light is detected by a photodetector and converted into an electrical pulse. The number of pulses generated here is directly proportional to the number of cells that pass through the detection zone within a specific time interval.

In the optical method, the light scattering from the individual cell passing through the detection zone is measured at different angles. In this way, the scattering behavior of the respective cell in relation to the optical radiation is detected; this allows conclusions to be drawn about the cell structure, shape and reflectivity, for example. This scattering behavior can be used to differentiate between different types of blood cells and to use the derived parameters for diagnosing deviations of the blood cells of this sample from a standard, which is obtained from a multiplicity of reference samples classified as standard, for example.

In the automated evaluation of cells in blood smears, current analyzers operate with microscopes with a high numerical aperture and with an immersion medium between the object carrier and the objective lens in order to be able to achieve a high resolution. However, this results in a comparatively small depth of field, which is significantly less than the thickness of cells perpendicular to the surface of the object carrier with the blood smear. Accordingly, the entire depth information of the cell cannot be imaged in focus by way of two-dimensional imaging with only one focus setting.

Therefore, there often are unclearly classified blood cells, which subsequently have to be classified manually by specialist staff, e.g., a laboratory physician. To this end, the object carrier with the blood smear is placed under a microscope again; the corresponding cell must be searched for with much outlay and inspected by the laboratory physician. For a reliable classification, the laboratory physician usually also focuses through the cell in this case in order to be able to better identify and evaluate the structure of the cell along the focus direction.

WO 2007/044725 A2, Bahram J., et al.: “Three-dimensional identification of biological microorganism using integral imaging” in Optics Express, vol. 14, no. 25, pages 12096-566, Kim J. et al.: “A single-shot 2D/3D simultaneous imaging microscope based on light field microscopy”, in Visual Communications and Image Processing, vol. 9655, pages 9655101-9655104, and WO 2010/121637 A1 describe optical imaging apparatuses.

In respect of the optical system, measuring devices currently used in hematology comprise a microscope with an approximately 100-times magnification with effective lateral resolutions of the sensor element in the object plane of 100 nm=0.1 μm. The usual cameras have pixel numbers of no more than 0.3 to 1 million pixels. As a result, the field of view in the object only has a size of a few 100 μm. In order to be able to capture and analyze the stained smear of a blood sample, which may be a few mm wide and several 10 mm long, the area of the region of the smear to be analyzed must then be scanned using a meandering scanning method by means of a displacement unit. To slightly accelerate the process, a first area-type scan is performed with a lower magnification, e.g., 10-times with a corresponding field of view 10-times larger, and, following a first image evaluation for finding the cells to be measured, only the regions of interest (RoI) with the cells are subsequently approached in a targeted fashion with the higher magnification. This means that there is not a complete, full-area analysis of the sample at the high magnification. In order to make the cells sufficiently well visible so as to be able to analyze them using high resolution optical microscopy, the blood smears are stained in a preceding step. A plurality of staining protocols have become established over the world, which, as seen from a global point of view, partially differ from region to region. Consequently, the comparability of the analysis of blood smears is restricted to regions, since there can only be a good comparison of images of cells with one another which have been stained according to the same protocol.

### SUMMARY OF THE INVENTION

An object underlying the invention consequently lies in the provision of an automated analyzer for analyzing cells in a sample and of a method for ascertaining two-dimensional or three-dimensional information about the cell, wherein a chemical pretreatment of the cell, for example, should be omitted to the greatest possible extent prior to the image capture and hence the analysis in order to be able to examine the cell in a state that is as close to the original state as possible and that has been altered only to a small extent or not at all.

The object is achieved by an analyzer according to the invention and by the methods according to the invention, as claimed in the independent patent claims. Advantageous developments of the invention are also given, in particular, by the dependent claims.

The subject matter of the invention comprises, in particular, an analyzer for analyzing cells in a sample, the analyzer comprising an optical microscope for imaging a light field in an object region and/or an object plane for the purposes of imaging cells of the sample, the microscope comprising a light source for illuminating the sample and a converging lens for converging and focusing light beams emanating from the illuminated sample, and a digital recording device for recording the light beams, wherein a light field camera for capturing the light field from the object region imaged in the microscope is provided on the microscope and wherein the light field camera comprises the digital recording device.

The digital recording device preferably comprises a detection appliance for the light beams and facilitates the conversion of the detection signals of the detection appliance into digital data.

An analyzer according to the invention is advantageous in that staining of samples for the subsequent microscopy process, as required until now, can be dispensed with in full or in part. The analyzer according to the invention provides highest-quality image data with a correspondingly large information content, which can be used for an automated evaluation and classification, for example. In this case, the captured image data have such a high quality that a subsequent examination of the sample by way of another observation under the microscope is no longer necessary. Consequently, the invention provides a complete digitization station for the cell, with a high resolution for lateral structures even over the entire extent of the depth of the respective cell, with staining and/or marking of the blood cells, in particular, also not being required for capturing an image.

### BRIEF DESCRIPTION OF THE DRAWINGS

The invention will be explained in more detail, once again, by way of a specific exemplary embodiment on the basis of the attached drawing. The shown example represents a preferred embodiment of the invention. In detail:

FIG. 1 shows an automated analyzer for analyzing cells in a sample.

### DETAILED DESCRIPTION OF THE INVENTION

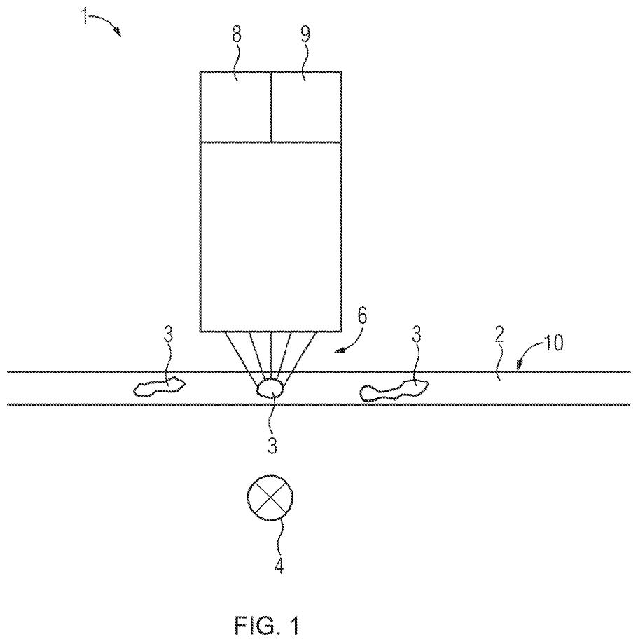

The automated analyzer for analyzing cells in a sample, shown in FIG. 1, comprises an optical microscope (1) comprising a light source (4) for illuminating a sample (2) and a converging lens for converging and focusing light beams (6) emanating from the illuminated sample (2). The sample (2) is a blood sample containing blood cells (3). The sample (2) is located in a microfluidic flow cell (10). Further, the microscope (1) comprises a light field camera (8) comprising a digital recording device, the recording device comprising a CCD chip or CMOS chip for capturing the light field imaged in the microscope (1). Further, the microscope (1) comprises a further camera for capturing an image in the object plane, the further camera being embodied as a high resolution 3-chip color camera (9). The lateral resolution of the color camera (9) is four times that of the effective lateral resolution of the light field camera (8). The focus of the color camera (9) is set on a central region of the measuring range of the light field camera (8), e.g., to a virtual depth ranging between 3 and 5. The incoherent illumination Sigma on the microscope (1) is 1.0. The microscope (1) is a microscope that can also be operated as a differential interference contrast (DIC) microscope (1).

Preferably, the analyzer according to the invention is an automated analyzer, particularly preferably a partly automatic or fully automatic analyzer. Preferably, the microscope comprises the light field camera. Preferably, the light field camera comprises the digital recording device, which is embodied to capture the light field imaged in the microscope. Preferably, the digital recording device comprises a charge-coupled device (CCD) chip or a plurality of CCD chips. Particularly preferably, the digital recording device is based on complementary metal oxide semiconductor (CMOS) technology and/or comprises a CMOS chip.

Preferably, the sample is introduced into the automated analyzer in fully automatic fashion, for example, by way of appropriate flow systems and/or a displacement of sample carriers within the analyzer, preferably by means of appropriately controlled actuators or robotic systems.

Preferably, the light field camera comprises a microlens array with lenses with different focal lengths, wherein the microlens array can image an intermediate image of the light field imaged in the microscope onto the digital recording device. Here, the microlens array has a minimum distance of one focal length from the intermediate image and there is real imaging. Thus, according to the invention, it is not aperture images that arise but real, small image sections within the meaning of smaller partial images of the object or the sample. The image information is then projected back through the optical unit until the beams of corresponding image points of different partial images meet. Thus, no directional images are captured in the present case but small object images.

The invention is based on an optical microscope which is equipped with apparatuses for differential interference contrast, for example. In respect of the split, such microscopes can be adapted to the requirements of hematology. This adaptation is substantially implemented by a targeted choice of the beam offset on the beam path through the test object. By way of example, the test object is a smeared blood sample.

The beam offset is determined by the thickness of the DIC (differential interference contrast) prisms in the illumination module and in the analyzer module. Here, the optical thickness of the two prisms and the direction of the beam offset must be matched to one another so that the analyzer module can completely reverse the beam offset from the illumination module again, and hence be able to compensate this. This allows the physical thicknesses of the prisms to deviate from one another on account of different imaging scales. There can be a plurality of pairs of DIC prisms for an objective lens in a microscope, which allow different splits.

Further, a light field camera, also referred to as a plenoptic camera, is provided at the microscope; it captures the light field from the object plane imaged in the microscope.

Preferably, the light field camera has an effective f-number (working f #) in the range of 10 to 30; particularly preferably, it is 26. Depending on the sought-after scanning of the test object using sensor elements, a suitable magnification is chosen to this end, the latter taking account of the size relationship between the real sensor element, typically in the range of 1 to 10 μm, and the scan of the object, which is in the range between 0.05 and 0.5 μm, with, preferably, the range preferably being between 0.05 μm and 0.15 μm on account of the high resolution requirements during the measurement. This then yields effective system magnifications from the object to the detection device ranging between 10-times and 100-times, preferably ranging between 20-times and 65-times, and particularly preferably ranging between 40-times and 65-times. If an immersion liquid is used for the required high resolution, the numerical aperture can adopt values in the region of 1.4. If the sample is surrounded by air, the numerical aperture is restricted to a value of no more than 1, technically of no more than 0.95 or 0.9.

The image side NA emerges from the object side NA divided by the magnification NA_image=NA_obj/M.

The numerical aperture NA and the f-number (f #) of the optical unit are linked via f #=1/(2*NA).

For magnifications of 40 and 63 and numerical apertures of 0.95 and 1.4, a corresponding f # in the range between 14 and 33 arises.

Preferably, the light field camera is, for example, a Raytrix R12 Micro Series light field camera from Raytrix GmbH, Kiel.

The image of the object at different depths can be reconstructed from the light field, corresponding to different focus settings of the microscope. This purely digital refocusing can be carried out at a later stage in the captured data records.

The analyzer according to the invention is advantageous in that depth information D (depth) is also available in addition to the color information RGB; this depth information can be used as a further feature in a manner analogous to a color channel during a subsequent computer-based evaluation.

By way of example, the cells can be segmented more easily on the basis of the additional depth information, i.e., be identified for the further analysis and cut out of the image. In addition to color contrast transitions, transitions also arise at the edges of the cells in the height profile, which are able to be detected easily and accurately.

A problem existing until now in conventional systems is that of reliably determining the edge of the cell on the basis of a color image only, because a threshold is usually used to this end and this threshold is already located within the cell due to the system since a certain change must have already taken place to reach that threshold. Therefore, cells are usually systematically measured to be smaller than they are. This is bothersome in the case of volume measurements and attempts are then made to correct this, for example, by way of interpolation algorithms. The provision and use of the depth information allows these problems to be solved easily and reliably since the background of the object carrier represents a plane on which the profile falls. Then, the known processes for determining the cell edges geometrically on account of height profiles can be applied accordingly.

By capturing the light field using the light field camera, the recorded image, e.g., of the blood smear or of the cells, can still be refocused offline following the image capture. Firstly, this can be used to focus the cells to the best possible extent for a segmentation and identification for the purposes of a classification or else for the segmentation and classification of a plurality of focal planes in parallel. Alternatively, use can also be made of volume data or 3D point clouds. As a result, the segmentation and classification can be implemented with a greater accuracy.

Should the images, e.g., of the cells, have been captured using the light field camera, there is the option of focusing through the images at a later stage, i.e., offline, in a purely digital fashion. In the case of an unclear classifications or evaluations of cells by the computer, this would give the physician the option of looking at the cells directly in the digital image and not having to initially return the object carrier under a microscope again, having to search for the cell, and then having to undertake a more accurate evaluation and classification by varying the focus. Since coordinate systems of the cell analyzer and the microscope are not matched to one another, the physician could previously only position the cell to be examined in the microscope with an approximate specification of the location and would have had to finally search for the cell with the microscope. This is time-consuming and should be implemented in the laboratory. However, if the digital image of the light field camera is available in accordance with the present invention, the physician can focus through the cell or structure in question directly in the digital image.

This evaluation and classification then is also possible within the meaning of telemedicine if there is a data link between the physician and the image or the image database such that the physician no longer need go to the object carrier in the laboratory.

In the case of unclear findings, this also facilitates the consultation of a colleague, to whom the image is sent for analysis purposes or for whom the image is made available, for example, via electronic networks; in the case of digital data transmission, this can be implemented virtually in real time. For an evaluation and classification of the captured light field images of the blood cells, the respective physician only requires appropriate analysis software on their digital terminal or else, within the meaning of a cloud solution, it is not only possible for the image of the light field camera to be stored in the cloud, but the evaluation can also be implemented in a cloud-based application, for example, via a web browser interface.

Preferably, the magnification is determined from the requirement of the optical resolution for scanning the test object, the choice of the magnification generally being linked with the required effective f-number or the numerical aperture.

The lateral resolution is preferably 100 nm in the object plane. Then, the magnification arises together with the lateral dimension of a sensor element as

M=lateral dimension of the sensor element/100 nm.

By way of example, this magnification is particularly advantageous for imaging blood cells.

The typical resolution limit of light microscopy in the case of a water, oil, or glycerin immersion is approximately 100 nm. In the case of a known pixel dimension of the camera of, e.g., 4.5 μm, the required magnification would consequently be 45 times. The aperture then arises from the aperture in the object plane—in the range greater than 1 in the case of immersion, typically 1.2 to 1.4—divided by the magnification, i.e., NA camera=1.4/M, e.g., 1.4/45=0.031. Then, the f-number then emerges from f #=½*NA as f #16. Preferably, the f-number of the camera is 2.4, 2.8, 5.6, 7.0, or 26.0. Particularly preferably, the f-number f # of the camera is 26 and the magnification is 63 times.

In the case of a pixel dimension of the camera of 2 μm, a magnification of 20× is preferred for the sought-after resolution in the object plane. Hence, NA camera=1.4/20=0.07 and consequently, the f-number f # is 7. This is advantageous in that high-resolution camera chips with a large number of pixels can cover large fields of view and, furthermore, the outlay for the optical system can be minimized.

Preferably, the analyzer is a hematology analyzer, particularly preferably an automated hematology analyzer.

Preferably, the medical sample comprises a cell and/or a medical preparation. Preferably, the medical preparation relates to a tissue section, sediments of bodily secretions, and/or bodily fluids and/or microcrystals.

Particularly preferably, the sample is a blood sample and/or the cell is a blood cell.

Instead of blood cells, the sample can preferably be any type of human, animal, or plant cell. This is advantageous in that very different sample types, including very different cell types, can be examined and characterized.

The combination according to the invention of a light field camera with a microscope for hematology is still significantly complemented by way of extended contrasting processes such as, e.g., phase contrast or differential interference contrast (DIC).

Preferably, the microscope is an amplitude contrast microscope and/or a phase contrast microscope and/or a differential interference contrast (DIC) microscope.

Preferably, the microscope is a differential digital holographic microscope.

The extended contrasting processes and, in particular, the DIC thereof, allow phase differences in the light paths through the sample, i.e., for example, the cells in this case, to be made visible. Then, different phase values can be represented by different colors, for example, particularly in the case of the phase contrast and can thus be measured using a color camera. As a result, it is possible to dispense with the staining of the samples but nevertheless image the cells with a good contrast. Previous systems for automated cell classification only used the amplitude contrast, which arises from staining the cells and from the different paths of the light in the cell or, alternatively, the surrounding medium.

As a result of the combination according to the invention of a microscope and a light field camera, additional 3D information about the cell is obtained and can be used to classify the cell. Consequently, the data for classification of the cell set forth below is obtained, depending on the chosen contrasting process in the microscope. By way of example, the classification can be carried out by specialist medical staff and/or computer-based systems. In the case of an amplitude contrast, conventional image information and additional 3D information about the cell are available. In the case of a phase contrast, a phase image and additional 3D information about the cell are obtained. In the case of DIC, a DIC image relating to differential phase images and additional 3D information about the cell are obtained.

According to the invention, the 3D information about the cell obtained can be advantageously represented in different ways, for example, as set forth below.

Advantageously, the 3D information of the cell is represented by an RGB image. Advantageously, the RGB image is imaged in focus over the entire depth of field range of the light field camera, as a so-called total focus image. Hence, more depth information is captured as a result of the increased depth of field range in comparison with conventional 2D cameras. Depending on type and alignment, a blood cell has a thickness of approximately 1 to 2 μm, up to approximately 20 μm. The depth of field of the image in the case of an NA of 1.3 and a wavelength of 500 nm is only d=±λ/NA\hat{ }2=±500 nm/1.69=±300 nm. Consequently, none of the cells are imaged in focus over their full depth in the conventional 2D image. The depth of field is increased by at least a factor of four by way of the plenoptic effect of the light field camera. Consequently, cells, e.g., in particular red blood cells (RGB), are imaged completely in focus. Additionally, larger cells, such as, e.g., white blood cells (WBC), are imaged in focus over a substantially larger part of the cell volume.

In a further advantageous configuration, the 3D information of the cell is presented as RGB D information. Every picture point contains depth information referred to as D. If, e.g., blood cells are applied as a sample to an object carrier, for example, then D is the thickness of the blood cell, for example. This information complements the color information and is also referred to as 3D point cloud.

In a further advantageous configuration, the 3D information of the cell is represented as volumetric 3D information. In a manner analogous to an image of the computed tomography device (CT), spatial image information thus arises in the form of voxels. Since the cells, e.g., blood cells, are at least partly transparent to the radiation, different points in the cell can generate scattered radiation, which is captured by the camera and assigned to different depths.

In a further advantageous configuration, an image stack can be calculated from the data record of the light field camera, which image stack is calculated at different focal planes and thus contains the volumetric information. In the evaluation algorithm of the light field camera, the so-called virtual depth lends itself as a spacing for these planes. Alternatively, the focal planes can also be calculated with different spacing values which, e.g., are chosen to be equidistant, with one of the planes coinciding with a maximum cross section of the cell.

In the case of contrasting with a phase contrast, the image of the light field camera is only based on the intensity modulations generated by the phase effect since the amplitude modulation and intensity modulation from the object itself are filtered out in the phase ring. This is a largely true color image in relation to the image with a pure amplitude contrast.

In the case of DIC contrasting, the image of the light field camera is based on an image of the cells which, by way of the differential interference contrast, contains information about the different paths of the light passing through the cell and hence the phase shift of the light as color-coded information. This is advantageous in that the color representation of the cell superimposes a fine structure, which greatly assists the evaluation algorithms of the light field camera in respect of a higher lateral resolution when calculating the depth information.

In an advantageous configuration, use is made of up to four color channels with RGB and white.

Advantageously, the spectrum of the illumination comprises the visible range and/or near IR wavelengths.

Preferably, there is a color balance between the light source and a camera, e.g., the light field camera. Further, the exposure time and the gain are preferably adapted for the 3-chip RGB color camera for the 2D images. Particularly preferably, the light source comprises a 4 LED light source with RGB and W and a common brightness control.

In a further preferred embodiment of the invention, a further camera for capturing an image in an object plane in the object region is provided on the microscope in the analyzer, wherein the further camera has a lateral resolution equal to or preferably higher than the lateral resolution of the light field camera, wherein the resolution of the further camera is twice, preferably three times, particularly preferably four times the resolution of the light field camera.

The further camera preferably has a larger field of view than the light field camera. This facilitates a better and faster coverage of the sample.

Preferably, the focal plane of the further camera, preferably a 2D camera, is coupled to a marked plane of the light field camera. By way of example, this can be measured in terms of the virtual depth. What this can advantageously achieve is that both cameras supply good images at the same time.

In a further preferred embodiment of the invention, the further camera is a color camera, preferably a multi-chip color camera, particularly preferably a 3-chip camera.

This is advantageous in that a high resolution is ensured by way of the high resolution color camera, e.g., a high-resolution RGB camera. This is particularly advantageous since, as a matter of principle, the light field camera loses a factor of two in terms of lateral resolution and a factor of four in terms of two-dimensional resolution in order to obtain information for calculating the depth resolution. Consequently, this loss of resolution can be advantageously completely compensated.

The use of a multichip color camera, e.g., a 3-chip color camera, is advantageous in that a better color measurement and, in particular, pixel-by-pixel color determination is possible without interpolation and with a greater dynamic range, bringing further advantages for the classification of cells. Advantageously, color channels are balanced for an optimized S/N ratio. In the case of stained samples, for example, balancing is preferably carried out separately for each staining protocol. Advantageously, the 3-chip color camera is a 3-chip CMOS camera with a 3.2 megapixels per chip.

A 3-chip color camera is preferred over, e.g., a 1-chip color camera since a 1-chip color camera usually uses a Bayer pattern. Since the analysis of, e.g., blood cells in a hematology analyzer particularly depends on, e.g., a good color resolution and color fidelity and also on a good lateral structure resolution, the 3-chip camera is preferred in this case. The high resolution color camera supplies, e.g., an RGB image with a higher resolution and with typically better hues, i.e., more accurate hues, and lower noise, if the exposure is optimized separately for each of the color channels. In the case of the 3-chip color camera, the hues are separately determined immediately and without interpolation for each pixel.

Preferably, the hues of a color camera are subsequently still transferred from the RGB representation to, e.g., an HSV representation for hue, saturation, and brightness (value); this allows red blood cells, for example, where the red color is distributed homogeneously in the cell, to be easily segmented by way of the hue as a further or complementary process. This approach works well for all cells and structures which homogeneously have the same hue or which are stained with the same color. Advantageously, this segmentation can be combined with that performed by way of the depth values (D) in order to have a criterion for cutting out the cell that is as precise as possible.

The images of the two cameras are advantageously registered to one another by way of scaling and/or pixel interpolation should the effective pixel sizes in the images not fit together appropriately or be commensurable with an integer factor of, e.g., 1, 2, 3, etc. To this end, lateral displacements, twists, tilts, distortions, and/or optical distortions in the images and/or a defocus, as well, should advantageously be corrected as a matter of principle. Once the images have been registered to the required scope, new image data are calculated; these combine the higher lateral color resolution with the depth information from the image of the light field camera. To this end, the image of the color camera can be placed on the associated focal position in the evaluated depth image of the light field camera and, from there, the color representations and lateral resolutions can also be transferred to adjacent focal planes by way of the propagation of the light field, which is known from what was captured by the light field camera.

Here, the transfer can for example be implemented by way of interpolation in the lateral direction and via correspondence tables, for example, for the colors. Alternatively, a more complicated transfer can also be carried out by way of a true propagation calculation on the basis of the data measured by the light field camera together with, e.g., a phase retrieval. Here, evaluated image planes of the light field camera serve as sampling points and the further additional points are supported by way of the neighboring points. A comparatively accurate and comprehensive interpolation is possible on the basis of the one marked plane together with suitable continuity conditions for the optical fields and the associated calculated optical wavefronts.

Advantageously, this more accurate solution, which is typically very computationally intensive, is used for fine diagnostics, e.g., in conspicuous image regions, for cells with unclear findings and/or for pathological cells, where real-time capability is less important or unimportant. By way of example, fine diagnostics can also be implemented, for example, over the entire image or else only in image sections, e.g., on individual segmented cells, possibly extended by certain edge regions around these.

Depending on the arrangement in the beam path, the different, respectively advantageous variants for the arrangement set forth below are provided according to the invention.

The two cameras can be used and operated simultaneously on the microscope for the purposes of measuring cells or preparations which are stained or which supply a good contrast in the images without extended contrasting processes. In the case of living or moving cells or samples or in the case of examinations using microfluidic cells, it may be advantageous if the two cameras also record the images in time-synchronous fashion.

Here, use can be made of commercially available microscope tubes, for example, which mechanically facilitate the parallel operation of two cameras in one microscope. Here, there are different ways to split the beam, e.g., in terms of the splitting ratio or the splitting process such as spectral separation, polarization separation, etc., which can be chosen in appropriately advantageous fashion.

In the case of non-stained cells, which require extended optical contrasting processes, the structure of the system optionally provides, according to the invention, further preferred technical embodiments of the system.

Preferably, only one polarization direction is used for the color image. To this end, separation of the beam paths for the color camera and the light field camera is provided between the objective lens and the DIC analyzer or, alternatively, between the objective lens and upstream of the objective lens-side DIC prism.

Preferably, the split of the light field on the imaging side is already taken into account in the illumination module when aligning the polarization prior to the split, in such a way that the two polarization components have the desired intensity ratio, such as, e.g., 1:1 for a maximum contrast, downstream of the DIC prism and DIC analyzer. This allows light losses to be minimized in order thus to optimize the efficiency of the overall structure and minimize the required exposure times for a fast measurement.

Preferably, the beam path is separated between the imaging objective lens and the DIC analyzer for the two cameras using a polarization-neutral beam splitter. Then, a polarizer should still be arranged in the beam path to the high-resolution color camera, in such a way that the polarizer blocks the one polarization direction of the DIC beam path as completely as possible and allows the other polarization direction to pass to the camera with as little attenuation as possible. This polarizer can either operate in transmission or in reflection or can lead to a spatial separation of the differently polarized beams. This offers the advantage of having a structure with a less complex design which requires no special polarization-dependent adjustment; however, approximately 25% of the luminous energy is lost on account of this principle.

Advantageously, the images of the light field camera and the color camera are aligned and scaled in a manner fitting to one another such that the 3D information or height information of the light field camera can be used in, e.g., a topography image and, at the same time, it is possible to use and employ the color information from the color camera.

Preferably, the light field camera and the color camera capture at the same time. By way of example, this can be achieved by appropriate triggering. The triggering can be implemented by way of hardware or else by way of software. The triggering can also be implemented from a selected first camera to the second camera, which is also referred to as master-slave coupling. It is necessary to functionally ensure that the images are recorded with a specified temporal reference, ideally simultaneously. As a result of possible latency times in the hardware and software of the cameras and the respective actuation thereof, the trigger signals themselves may have temporal spacing. Capturing at the same time is particularly advantageous when capturing moving cells, e.g., in a flow cell, and/or living cells or test objects.

Advantageously, the images of the light field camera and the high-resolution, further camera are only combined in sections for image regions, e.g., only in a region in which an automated measurement process has recognized or detected test objects to be examined. This is advantageous in that an increased measurement speed can be achieved since computational outlay and computation time can be saved accordingly.

Different configurations may be advantageous, depending on the arrangement in the beam path.

In one advantageous configuration, only one polarization direction is used for the color image and the separation of the beam paths for the color camera and the light field camera is implemented still upstream of the DIC analyzer or already upstream of an objective lens-side DIC prism. The split of the light field can advantageously be taken into account in the illumination module when aligning the polarization prior to the split, in such a way that the two polarization components downstream of the DIC prism and the DIC analyzer have the desired intensity ratio, such as, e.g., 1:1 for a maximum contrast. This is particularly advantageous if stained cells should be imaged and analyzed, in particular.

In a further advantageous configuration, the color camera is used for high-resolution DIC and the plenoptic unit is used for an extended depth measurement range for unique unwrapping of the color regions for the purposes of measuring relatively thick cells or cell clusters. A high-resolution relative thickness measurement is therefore implemented by means of DIC by virtue of the differential contrast information being integrated, for example, and there being a relatively large area assignment by means of plenoptic unit.

In the case of non-stained samples, e.g., cells, the amplitude contrast contains hardly any information or no information and the color image is advantageously only used for phase or DIC contrast, which then however has a high lateral resolution with a real color separation per pixel.

In an advantageous configuration, the light field camera and the high-resolution camera, which advantageously comprises a color camera, are aligned relative to one another with respect to the axis directions of the sensor array and advantageously also with respect to the subpixel-accurate shift along the axis directions of the array and/or a direction-dependent scaling factor for, e.g., the x-axis and/or y-axis.

In one advantageous configuration, the position of the focus of the high-resolution camera is set to the central measurement region of the light field camera. This is advantageous in that the light field camera can procedurally also be used in a manner similar to an autofocus system.

The achievable depth resolution of the light field camera increases with a smaller working f-number f #. Thus, an f-number of 7 can be significantly more advantageous than an f-number of 26. A smaller f-number means a larger image-side aperture. Since the object-side aperture is restricted to 1.4 in the case of the immersion typical for biological samples, a maximum image-side aperture in relation to NA camera arises as 1.4/M.

Advantageously, the object on the microscope is already illuminated with the whole imaging aperture in order, on the image side, to illuminate the full aperture of the working f # so that the light field camera works well and is able to provide detailed lateral scanning. The most expedient case is NA illumination=NA objective lens. This is also referred to as incoherent illumination with Sigma=σ=NA illumination/NA objective lens=1.

In an advantageous configuration of the automated analyzer according to the invention, the incoherent illumination Sigma is greater than 0.8, preferably greater than 0.9, particularly preferably 1.0 on the microscope, wherein Sigma is given as the ratio of the numerical aperture of the illumination of the sample and the numerical aperture of the objective lens and wherein the microscope is preferably a differential interference contrast (DIC) microscope.

In hematology, this σ=1, or σ>0.8 or more desirably σ>0.9, is very important since the blood cells are weakly scattering objects and consequently the aperture is filled sufficiently with light, even for a microlens array in the light field camera.

Previously, illuminations according to Köhler with Sigma=0.7 were used, as a rule, in light microscopy for the purposes of optimizing the contrast—in particular for the visual observation, but also in the case of cameras. However, this would lead to an aperture not sufficiently filled with light in this case and consequently there could not be a very accurate depth determination. Moreover, the majority of the spatial resolution would be lost on account of the not fully illuminated pixels. This is connected to the fact that the used number of pixels increases approximately quadratically with the value of Sigma for the calculation of the images and the maximum near the complete detector resolution is reached at σ=1.

In an advantageous configuration of the analyzer according to the invention, the analyzer comprises a sample supply appliance for object carriers, by means of which samples on an object carrier can be supplied to the analyzer.

In an advantageous configuration of the analyzer according to the invention, the analyzer comprises a flow cell for supplying the sample, with the object plane of the microscope preferably lying in the flow cell. Preferably, the flow cell is a microfluidic flow cell.

This is advantageous that, in particular, cells or blood cells can be imaged and analyzed in natural surroundings. In particular, it is possible to avoid the necessity of applying the cells in the form of a smear to an object carrier, where they are frequently desiccated and/or stained, which can significantly alter their original natural properties such as, e.g., the shape. Furthermore, it is possible to dispense with the corresponding preparation outlay for the production of smears and the staining, and significant amounts of waste are avoided as a result of no longer consuming, e.g., object carriers and coverslips for the smears. Likewise, storage capacities in respect of the smears and consumables are no longer required. On the system level of the analyzer, the apparatuses for automatically changing the smears can be dispensed with, facilitating, inter alia, a significant simplification of the device structure.

Since the usable layer in a flow cell typically has a thickness of a plurality of micrometers, sometimes even several 10 μm, it is difficult to position the cells accurately in the object plane of the microscope optical unit used for the examination. In this respect, there are clashing interests of the desire for a higher resolution on the one hand and the not quite as precise positioning of the cell in the direction of the optical axis on the other hand.

Preferably, the depth measurement of the light field camera can then serve here the purposes of optimizing the actuation parameters for the microfluidic system in order thus, for example, to suitably set the focus so that even the two-dimensional high-resolution images are in focus. Exposure and the 3D images also provide added value without interferometer, as in the case of DHM, which is complicated and complex and, in part, has disturbances as a result of effects with temporally and/or spatially coherent radiation.

The lateral resolution improves with increasing numerical aperture NA of the optical unit, by way of the relationship δ=0.5 Λ/NA. Secondly, the depth of field reduces with the numerical aperture as per d=±λ/NA\hat{ }2. A 500 nm wavelength and NA=0.7 then yields a depth of field of 2 μm overall, which approximately corresponds to the thickness of red blood cells, for example.

In currently conventional devices, work is carried out using an optical unit with apertures of NA=0.5, which then corresponds to a depth of field d=4 μm overall at 500 nm. According to NA=0.5, the achievable lateral resolution is restricted to 5=0.5 μm. Thus, it was previously necessary to make a corresponding compromise for balancing the lateral resolution and depth of field by way of the selection of the numerical aperture. The aforementioned relationships describe the resolution of optical instruments according to current theory.

An automated analyzer according to the invention with a corresponding light field camera allows the depth measurement range, i.e., the region where images are recorded in focus, to be increased by a factor of approximately 4 to approximately 6. In contrast thereto, the lateral resolution of the light field camera reduces by a factor of 2.

Since the magnification and aperture can be chosen largely independently of one another when choosing the optical unit used, this effect can be well compensated, however. By way of example, if a higher magnification and a larger aperture are selected, the effect can be used in a correspondingly positive fashion.

By way of example, if a magnification of 60 times to 80 times and an aperture of NA=0.7 are selected, the following values roughly arise for a wavelength of 500 nm: NA=0.7, 5=0.36 μm, depth of field d=1.05 μm. With the effect for increasing the depth working range from the plenoptic camera, a value for an increased depth of field of d=5.25 μm arises, under the assumption of an increase by approximately a factor of 5.

By way of example, if a magnification of 60 times to 80 times and an aperture of NA=0.9 are selected, the following values roughly arise for a wavelength of 500 nm: NA=0.9, 5=0.28 μm, depth of field d=0.62 μm. With the effect for increasing the depth working range from the plenoptic camera, a value for an increased depth of field of d=3.10 μm arises, under the assumption of an increase by approximately a factor of 5.

Thus, the use according to the invention of the light field camera in a cell analyzer allows the depth working range to be greatly increased, which then accordingly facilitates the use of a flow cell. In particular, a more complete or complete detection of the extent of a cell is facilitated over the height of the flow in the flow cell. In particular, this facilitates precise examinations on typically non-stained cells. However, for certain examinations, it may also be advantageous or necessary for the cells in the medium of the microfluidic system to be stained.

A further advantage is that the parameters of the flow cell in respect of focusing and/or relative position of the cell may be located in a further parameter range and, for example, a corresponding special optimization may be able to be dispensed with.

In a preferred configuration, the field of view of the microscope comprises the full width of the flow cell through which cells can flow. Advantageously, this range has a width of a few 1/10 mm to a few mm.

In a preferred embodiment of the automated analyzer, the analyzer comprises both means to be able to view object carriers with cells and/or to be able to view cells in the flow cell. Here, the dimensions of the flow cell are advantageously matched to the dimensions of the object carriers, in particular the thickness and hence the optical effects thereof. The cover of the flow cell—i.e., the coverslip and optionally also fluidic media situated between the region or the plane of the cells and the outer surface of the flow cell—advantageously likewise have the same optical effect, e.g., in respect of optical path lengths, dispersion, and/or refractive index, such that the same optical units can be used and the same best possible imaging quality remains. Preferably, there can be refocusing, for example, to adapt to manufacturing tolerances. Typical cover glass thicknesses are in the range below 0.2 mm, typically between 0.15 and 0.17 mm. By way of example, the lateral dimensions of object carriers are, for example, 76 mm by 26 mm or 75 mm by 25 mm pursuant to DIN ISO 8037-1, with a thickness ranging between 1 mm and 1.5 mm. The dimensions of the flow cell then advantageously arise accordingly.

In a preferred configuration, the movement speed of the cells in the flow cell in the imaging region of the microscope is matched to the exposure time of the employed image capturing systems. Here, the movement is typically less than ½ pixel (pxl), preferably less than ⅕ pxl, particularly preferably less than 1/10 pxl. This is advantageous in that motion blurring effects can be reduced or entirely avoided.

In a further advantageous configuration of the analyzer according to the invention, the analyzer comprises a sample supply appliance for object carriers. This can be advantageous, in particular, if, e.g., tissue sections or other medical preparations are intended to be examined.

A further subject matter of the invention relates to a method for ascertaining two-dimensional or three-dimensional information about a cell by means of an analyzer according to the invention, the method comprising the steps of:

a) supplying a sample with a cell to the microscope,

b) recording the light beams emanating from the cell in the illuminated sample by means of the digital recording device,

c) imaging the light field imaged in the microscope from the object region by means of the light field camera, wherein the light field camera comprises the digital recording device, and

d) ascertaining two-dimensional or three-dimensional and/or volumetric information about the cell from information of the light beams recorded in step b) and/or information of the light field imaged in step c).

Advantageously, steps b) and c) can also be linked to form one step, the step then comprising:
imaging the light field imaged in the microscope from the object region by means of the light field camera, and
recording the light beams emanating from the cell in the illuminated sample by means of the digital recording device, wherein the light field camera comprises the digital recording device.

In step b), preferably, the light beams emanating from the cell in the illuminated sample are initially focused and then recorded by means of the digital recording device. Preferably, the photons are converted into electrical charge, there subsequently being a determination of an amount of charge and a digitization of the value for the amount of charge.

Instead of the cell, two-dimensional or three-dimensional information about a medical preparation can preferably also be ascertained accordingly.

Preferably, the sample is supplied to the analyzer by means of a flow cell in step a), with the object plane of the microscope lying in the flow cell. Preferably, the flow cell comprises means that allow an accumulation of cells in a marked plane in the flow cell by way of an appropriate actuation of the flow cell. Preferably, the object plane is set on the marked plane such that the object plane and the marked plane advantageously coincide.

Preferably, in step a), the sample is supplied to the analyzer on an object carrier by means of a sample supply appliance for object carriers.

Preferably, the method further comprises a step in which an image in an object plane in the object region is provided by means of a further camera for recording an image in the object plane in the object region, wherein the further camera has a higher lateral resolution than the lateral resolution of the light field camera, wherein the resolution of the further camera is preferably twice, particularly preferably four times the resolution of the light field camera and wherein the further camera preferably has a larger field of view than the light field camera.

Preferably, the further camera is a color camera, preferably a 3-chip color camera.

Preferably, the cells and/or the medical preparations are not stained. In this case, the extended contrasting processes such as, e.g., a phase contrast and/or differential interference contrast are particularly advantageous, in particular for imaging cells. Optionally, an amplitude contrast may also be advantageous in the case of, e.g., sediments or other samples.

In a preferred configuration of the method, the method further comprises the step of:

e) carrying out digital refocusing or a focus variation by means of the two-dimensional and/or three-dimensional and/or volumetric information of the cell, ascertained in step d), along the optical axis of the microscope, wherein, preferably, the digital refocusing is implemented in computer-assisted and/or numerical fashion.

This is advantageous in that the refocusing or focus variation provided according to the invention for the first time facilitates telemetric findings in hematology. Consequently, findings by way of consultation, e.g., by experts at other locations, or else subsequent findings, are facilitated. In order to be able to carry this out with the established high quality of the findings as per the standard of care, it is imperative to provide the subsequently examining or consulted physician with the option for focusing through the cell plane.

In the prior art, the corresponding object carrier with the relevant cells in question was previously physically retrieved from, e.g., a rack, a storage box, or an archive and then placed under a microscope, and the image was focused on the respective cell in each case. Attempts were then made to find the respective cells again on the basis of relatively imprecise spatial information in respect of the position of the respective cells on the object carrier. Findings are obtained if the cells are found again. For the findings itself, the physician analyzes the optical image of the cells and usually also focuses through the cell. Therefore, the previously known systems and processes are not suitable or only have a very restricted suitability for detailed subsequent findings since the physicians can no longer focus through the cell image once it is captured and hence depth information, which is important for the findings, is no longer accessible.

Thus, an advantage of the present invention lies in capturing the cell image as a three-dimensional image in order thus to provide the physician with freely adjustable focusing on different focal planes, which is selectable at any time, even subsequently, in the digitally stored image. In this case, the physician need no longer sit at a microscope themselves; instead, this process can be undertaken spatially and temporally independently of the sample. Since the image is available in purely digital form, there is no deterioration in the data over the time that has elapsed since the image was captured, in contrast with the previously most common procedures where the archived samples age over time and their state deteriorates. To obtain each subsequent finding, the sample has to be inserted back into the microscope and an immersion oil has to be applied. After findings are obtained, the sample is cleaned again, which may also lead to damage and, overall, represents a certain temporal outlay.

A further advantage lies in the fact that, if a plurality of cells are situated in an image, the focus can be subsequently set and varied accordingly in respect of each individual cell of the respectively imaged cells.

In a further preferred configuration of the method, the method further comprises the step of:

f) assigning the cell to a cell type on the basis of predetermined information and the two-dimensional, three-dimensional, and/or volumetric information about the cell ascertained in step d).

This is advantageous in that an automated assignment of the cell to a cell type can be undertaken in a particularly reliable fashion that is less susceptible to errors.

Further subject matter of the invention relates to a method for assigning a cell to a cell type, comprising a method according to the invention for ascertaining two-dimensional and/or three-dimensional and/or volumetric information about the cell, wherein steps a) to d) are carried out at a first location and wherein the information ascertained in step d) is digitally transferred to a second location via a data and/or network connection and wherein steps e) and f) are performed at the second location.

The subject matter of the invention also relates to a corresponding method for assigning a cell to a cell type, wherein, however, two-dimensional or three-dimensional or volumetric information about the cell is ascertained on the basis of any other suitable method for ascertaining two-dimensional or three-dimensional and/or volumetric information about the cell.

This is advantageous in that this enables telemedicine for hematology. By way of example, this allows findings by consultation from experts at other locations. Consequently, fine diagnostics of a recorded cell can also be undertaken by way of remote focusing. Further, this allows the consultation of a second physician for a subsequent classification or counter classification for verifying the diagnosis in the database. By way of example, this can also lead to the establishment of a ground truth data record with special and, in particular, rare pathologies which physicians can compile more easily and more efficiently worldwide by way of the remote functionality and obtaining findings using 3D images.

Advantageously, verified findings in cloud server data records are used for automatically extending a training data record, particularly for pathological cases.

Advantageously, a worldwide learning system is established. This allows relatively large data records to be compiled as quickly as possible, even for very rare clinical pictures. Then, these data records can advantageously also be used for automated computer learning algorithms such that, ultimately, a broader and verified basis is available also for the automated assessment and/or assignment of the cells.

Advantageously, the patient data are also kept available in a database. This is advantageous in that earlier data records relating to captured blood counts can also be analyzed for clinical pictures occurring at a later stage and this allows noticeable problems to be examined; for example, in the case of hematology, this allows discovery or identification of very early development stages of, or indications for, leukemia. Once this data has been learnt by a system, this analysis can be applied to the images in automated fashion and without additional outlay since the cell images are advantageously pre-evaluated by computers.

Preferably, the cells and/or the samples are presented by means of a 3D display device, preferably an autostereoscopic 3D display, for example. This allows the physician to be provided with a novel 3D visual impression of the cells and/or samples to be examined. In particular, this advantage is also obtained, according to the invention, in telemedicine.

Advantageously, a compact data format is used for the image data from the light field camera. The image data are preferably compressed. This allows the storage space required to be kept as small as possible, allowing the storage of the many patient data records; these can then be used as a ground truth, e.g., also for a computer learning system, within the meaning of automated medicine and/or as a valuable assistance system for physicians.

Advantageously, there is a use of cloud solutions and/or server solutions for storing images and data of the findings and, advantageously, also for saving extended data relating to the person, e.g., physician, the time, and the system, including configuration or else software version, behind the findings for the relevant cell, or else when and where the relevant sample was taken from the patient and information about the transport to the laboratory. Alternatively, this information can preferably also be provided via a link to a different storage system. Advantageously, the time of the findings is also correspondingly stored.

Further subject matter the invention relates to a method for digitally staining a cell, the method comprising a method according to the invention for ascertaining two-dimensional or three-dimensional information about a cell by means of an analyzer according to the invention and additionally the following steps:

g) digitally staining the cell in accordance with a predetermined assignment between the two-dimensional or three-dimensional and/or volumetric information about the cell and staining of a corresponding cell and/or a structure within the cell by means of a staining protocol, and

h) displaying an image of the digitally stained cell.

Preferably, a medical preparation sustained accordingly instead of the cell.

Advantageously, the two-dimensional or three-dimensional and/or volumetric information about the cell is geometric information about the structure of the cell or the medical preparation.

Here, two-dimensional information is understood to mean, e.g., image information which images an object region in a planar image with lateral coordinates in the X-direction and Y-direction, which describe and span the area. The individual image points of a two-dimensional image are also referred to as pixels.

Here, three-dimensional image information is understood to mean that, for example, the image additionally also contains depth information in the axial direction of the imaging beam path for at least one image point in addition to the planar image information, i.e., for example, depth information in the Z-direction which is linearly independent of the X-direction and the Y-direction. An example of a three-dimensional image information could be a contour image, for example, which produces the topography of the object in the z-direction.

By way of example, volumetric information refers to the image also containing information for different Z-values in the Z-direction, over a planar region in the X-direction and Y-direction. By way of example, the X-axis, Y-axis and Z-axis could each be divided by increments of the same size such that small volume elements arise, which are also referred to as voxels. Image information described by way of voxels is a type of volumetric information. By way of example, volumetric image data are used in tomography. If the voxel information is available only for a few image points or voxels, the information can also be presented in the form of so-called point clouds, where each of the points is represented by way of its X-coordinate, Y-coordinate, and Z-coordinate, for example. The volumetric information is an extended representation for a three-dimensional image information, which is advantageous, particularly in the case of more complexly structured objects.

To clearly interpret the image data with two-dimensional, three-dimensional, and volumetric information, it is generally necessary to know the coordinate system, e.g., Cartesian or cylindrical, and the orientation of the coordinate axes, used for defining the underlying coordinate system.

In further advantageous configurations, the two-dimensional or three-dimensional and/or volumetric information is information in respect of intracellular structures, such as, e.g., cell organelles and/or geometric structures of a tissue section. Information in respect of optical path lengths generally does not readily correspond to geometric information and, therefore, optical path lengths in this respect are not geometric information.

Preferably, the staining protocol is the May-Grünwald-Giemsa stain protocol, modified Wright staining, Wright-Giemsa staining, and/or Romanowsky staining.

Preferably, a color distribution according to any one of the aforementioned staining protocols is applied during digital staining of the cell. Preferably, images of the technical contrast are recolored from black/white or according to extended contrasting methods by way of color properties determined by computer learning. To this end, 3D and/or volumetric information is preferably used, since this is advantageous in relation to the use of a pure 2D color mapping.

The methods according to the invention for digitally staining a cell are advantageous in that the digital staining of the cells can be implemented at a later stage in the digital image. This dispenses with the additional steps of staining the slides within the scope of the sample preparation. This leads to significant savings in terms of time and costs. Further, this avoids differences between various laboratories or regions.

Within the scope of digital staining, this renders it possible for the first time to take account of differences between laboratories when implementing a staining protocol for the desired coloring or else the different staining protocols that are customary in different regions and to implement these in accordance with what is customary to the respective physician, independently of the location of the actual blood or tissue examination.

A further advantage lies in the fact that a switch between different staining models is possible, for example, to be more specific for certain pathologies.

Advantageously, the staining protocol is an artificial color model which, for example, emphasizes certain critical features in order to make findings easier for physicians or even allow inexperienced physicians, for example, to make a diagnosis. Here, the artificial color model can be configured in a manner similar to the false color representations for technical images, for example, like thermal or IR images, which are represented as a color image. Thus, even within the findings for one and the same cell, the staining models can easily be switched; this would not be possible in the case of conventional chemical staining.

Preferably, cells assigned to the various classes are digitally stained in different ways. Advantageously, all the cells that should not be considered at the current time are masked from the image. Preferably, alternatively, only a selected set of different cell groups is presented.

Preferably, the 3D information about the cells, possibly also in combination with the extended contrasting processes such as phase contrast or DIC, are used to replace the dispensed with color information of the dispensed with immediate staining with the 3D information. This allows the correspondingly learnt information in respect of the non-stained image to be converted into the color information as robustly as possible and in a less error susceptible fashion.

Preferably, the predetermined assignment between the two-dimensional or three-dimensional or volumetric information about the cell and staining of a corresponding cell and/or a structure within the cell by means of a staining protocol is ascertained in the learning phase, as set forth below.

To this end, the cell or the cells are initially imaged in a first image without staining. Subsequently, the cells are stained in accordance with the respectively desired staining protocol. Then, the stained cell or stained cells are imaged in a second image. Then, the cell (or the cells) are identified and segmented in the first and second image and the non-stained and stained cells are respectively assigned accordingly.

Advantageously, the cells are grouped according to cell type, e.g., red blood cells (RBC), white blood cells (WBC) (optionally including 5 part diff.) and/or classified, e.g., by means of computer learning and/or neural networks.

In the next step, there is computer learning of the characteristics of the staining for each of the cell groups separately from one another and, subsequently, a specific digital staining prescription is created for the non-stained cells, advantageously in separate fashion for each cell group.

To verify the digital staining prescription, the staining is then applied to the non-stained cells and there is a comparison including an evaluation of the result of the digital staining with respect to the actually stained sample, with a look that is as similar as possible between the stained and digitally stained cells being sought-after. Advantageously, the result is then evaluated on the basis of predetermined quality criteria and/or according to the maximum permissible residual deviations. On account of the question of color fidelity, which is always very critical within the scope of medicine, the color deviations can also be evaluated in respect of an external reference standard, as is described, for example, in DICOM for displays and display devices. Since the standard has not been written for this application, the evaluations can possibly only be transferred and applied in analogous fashion. The staining model is accordingly created, checked, and stored individually or in targeted fashion for each staining protocol and each cell group.

Preferably, the procedure set forth below is carried out for digitally staining a cell. Initially, the desired staining protocol is selected and the non-stained cells are imaged in a first image. The cell or the cells are segmented in the first image. Then, there is an assignment of the cells to cell groups and/or a determination of the cell type for the selection of a cell-specific staining model. The cell or the cells are stained in the next step. Subsequently, a digitally stained image, e.g., of a blood smear, is displayed on an output unit.

Advantageously, the same non-stained image is stained using the appropriate staining that is conventional in the respective region. This allows common findings for a sample by experts who are used to different forms of staining.

An interchange of the respective staining protocol is also possible at all times, independently of whether the original blood sample is still present, for example, in order to create further blood smears. A further great advantage of digital re-staining is that one and the same cell can be stained differently, which is not possible in the case of chemical staining of the real cell. This also allows, for example, a region-overarching consultation beyond the previous boundaries of staining protocol applications. On account of the information being available in completely digital fashion, previous problem areas are also rendered superfluous, such as, e.g., bleaching of the sample over time.

Further, this allows the application of staining protocols within the scope of possible subsequent examinations of specific patients that were unknown or unavailable at the time of the original findings. This allows the medical advance in respect of the standard of care to also be applicable for existing samples or their images, and this may lead to correspondingly higher-quality findings.

Previously, the blood smears were stained in a preceding, complicated step in order to make the cells in the blood smear sufficiently well visible for the microscope and the observation by the physician, and so the cells can be analyzed using high resolution optical microscopy. This process has been conventional and established for many decades. Worldwide, different staining protocols, such as, e.g., May-Grünwald-Giemsa, modified Wright stain, Wright-Giemsa stain, and/or Romanowsky stain, have become established in this respect, wherein laboratory-specific differences may arise even within one protocol since some laboratories slightly adapted the staining according to their desires. This leads to the comparability of the analysis of blood smears being restricted, in particular since only cells stained according to the same protocol can be easily compared with one another within the scope of automated analysis and classification of blood smears. A further disadvantage of the previously used procedure is that the stain requires an application time of approximately 10-15 minutes on the smeared blood sample. This can be very disadvantageous in the case of analyses in respect of acute clinical pictures.

The digital staining of a cell according to the invention preferably relates to an image of a preferably non-stained cell digitally captured in an analyzer according to the invention. Then, this image of the cell is stained within the scope of post-processing in the way that physician is accustomed to for cells stained according to the different conventional staining protocols.

Preferably, supplying stain to the sample for staining the cell should be avoided where possible, at least before the sample has been imaged once.

Preferably, according to the invention, different staining protocols can be selected using the novel digital staining for different cell types, for example, because the specifics of the staining protocols fit particularly well to the respective cell type. Thus, a physician or hematologist or pathologist could create personal staining schemes, within which certain staining is assigned to a cell type and the previous restriction of only one stain per slide is completely broken and lifted. As an extension to this “individual” staining, generic digital staining protocols can advantageously also arise, the staining protocols further exploiting the technical color space for the better identifiability of features and structures. In each staining step, chemical staining typically operates substantially by way of one stain, which accumulates in different amounts at suitable binding-capable cell structures. The more stain accumulates, the more light from the spectrum of the illumination light is absorbed in accordance with the absorption spectrum of the respective stain. Thus, the transmission image contains a higher color saturation (S) for the color value(s) of the stain (V). The effects superpose if a plurality of stains which bind to different parts of the cell structure are applied simultaneously or in sequence within a staining protocol. Each stain then changes the saturation value S for its specific color value V according to the amount of stain accumulated. The number of altered color values V is restricted by the number of stains and their specific spectral characteristics. Typical stains in medicine lie in the red-blue range such that, e.g., color values in the green or yellow spectral range remained virtually unchanged. Advantageously, digital staining can operate both with sharper color separation and with a broader coverage in the optical spectrum.

However, it may be advantageous in some examinations to not completely dispense with the addition of stains and/or pharmaceutical and/or chemical additives. By way of example, in the case of reticulocytes, the stain, in addition to the pure color effect, has the desirable side effect of clumping together the RNA still available in the cell and only rendering the latter imageable and contrastable in the microscope thereby. Non-clumped RNA is smaller in terms of dimensions than what would be resolvable using conventional optical microscopes.

The subject matter of the invention is based on an optical microscope which advantageously is equipped for capturing images with extended optical contrasting processes. These extended contrasting processes can comprise, e.g., phase contrast (PC), differential interference contrast (DIC), polarization contrast (POL), interferometry (preferably in the embodiment as a digital holographic microscope (DHM)), hyperspectral imaging (pure color contrast in an extended spectral range, e.g., UV, VIS, NIR, MIR and/or FIR or selected portions therefrom), and/or structured illumination (e.g., with predetermined intensity distributions and/or phase distributions, preferably set the pupil plane).

Preferably, different contrasting processes are available in parallel on a microscopy system, in particular, if these can be used, e.g., without interaction among one another. Otherwise, the different contrasting processes are preferably carried out successively in time. If the different contrasting processes are carried out successively in time, particle image velocimetry (PIV) is preferably provided according to the invention in order to track the respective trajectories since the cells move between the images in the case of a combination with a microfluidic system. This allows the color information obtained in the different modalities to be brought together again correctly for each cell. Preferably, PIV also comprises the rotation of the cell and, advantageously, the defocussing as well.

By way of the extended contrasting processes, the samples are provided with, e.g., a color contrast from the interferences, for example, DIC or polarization, which then ensures a good resolution of the structures in the cell in the digital image and/or facilitates good contrasting for the cell.

According to the invention, it is particularly advantageous if 3D information is also available in addition to amplitude or intensity information and possibly color information as well. The images of the light field camera for the 3D capture can also be available as volumetric and/or tomographic data. According to the invention, this 3D information also allows subsequent, purely digital defocussing in the captured image. In this context, this is particularly advantageous for allowing the physician to check the automatic classification and for the specific and reliable assessment of pathological or conspicuous cells.

According to the invention, new staining modes are preferably provided within the scope of digital staining, with the currently displayed staining only depending on the region of the cell, which, e.g., is located below the focal plane. This can further improve the 3D depth perception of the physician. Alternatively, use could also be made of regions above the current focal plane only, or else of regions within a certain adjustable layer thickness around the specific focal plane.

Thus, for digital staining according to the invention, an image captured microscopically using one of the systems according to the invention is then postprocessed in such a way that it looks like it probably would have looked if stained cells were recorded using a conventional microscope. For implementation purposes, a certain number of non-stained samples with a multiplicity of cells are captured in the novel system for each staining protocol. The cells can be identified and segmented manually or automatically in the image for comparison purposes. Then, the same samples are stained using the desired staining protocol and the same cells are subsequently captured again using a microscope. Here, it is important that the microscope has a good color fidelity and a color camera, particularly preferably a color camera that is optimized for the best possible true-color image capture, the color camera optionally having also been calibrated using specific samples or calibration procedures, e.g., pursuant to the DICOM standard in medicine.

Typical color cameras have a Bayer pattern, in which 50 percent of the pixels are predominantly sensitive to green, 25 percent of the pixels are predominantly sensitive to blue, and the remaining 25 percent of the pixels are predominantly sensitive to red. To obtain complete color information in respect of the RGB values for each pixel, the color values of the adjacent pixels of the corresponding colors are interpolated for the color value to be determined, for example. Optionally, continuity information from the pixels of other color values are also considered and used. Preferred color cameras are, e.g., 3-chip color cameras, which directly measure an intensity value for red, green, and blue in parallel for each image point. Thus, these preferred color cameras should be cameras that directly measure the required color values for each pixel.

Since the information of non-stained cell and stained cell is available for each cell, the color information can be linked between the two samples, preferably by way of processes of computer learning, for example. Preferably, this link is implemented separately for each class of cells in order to capture the specific staining behavior to the best possible extent. To simplify the outlay and scope of learning, it is alternatively advantageous to learn the same cell types, which are, e.g., in different development stages, together. Advantageously, this could be implemented, e.g., in the case of red blood cells which are available in different aging states with slightly different geometric shapes. It is likewise advantageously possible in the case of white blood cells to train the 5 main groups, which are distinguished in 5-part deferential diagnostics, together. Then, it may be advantageous to learn the stains of specific features within such a group in a second step in order to obtain best possible and comprehensive color contrasting.

Particularly preferably, within the scope of learning, the 3D information, e.g., in the form of topographic information or as volumetric or tomographic information, is also processed in addition to the pure 2D information, as is available from normal camera images in the current systems. For the learning, this 3D information and, advantageously, information derived therefrom, e.g., of an effective 3D profile, can be used both for the non-stained image and, preferably, for the stained image as well. In principle, all known methods of computer learning are applicable for the learning, such as, e.g., PLS, PLS-DA, PCA, or else neural networks (CNN) or deep CNNs.

For a good learning result and in order to achieve digital staining that is as realistic as possible, it is advantageous if the classification per cell type to be learned and/or per group of cells learned together is implemented in at least as many color values as are distinguishable in the original sample and/or as are representable on the display device. In the case of computers, color spaces are conventional for the color representation, wherein, e.g., 256 color values, i.e., 8-bit or 1 byte color depth, or 65536 color values, i.e., 16-bit or 2 byte or 1 double byte, are used per color for each pixel.

To efficiently save data volume, it may be advantageous to select a different representation of the color space and/or of the color values than RGB. Since the effective color values may differ between the cell types and, in an idealized fashion, only differ in terms of saturation or brightness within one cell type, a color value and brightness value are advantageously stored. This is advantageous in that the full color information need not be stored in RGB for each image point. This advantageous representation would be comparable with, e.g., an HSV or HSL color representation. On account of the frequently comparatively similar colors in the images, the potential for saving storage space and/or data volume is particularly high here.

A significant advantage of the digital staining according to the invention is that samples can now also be compared between different regions, where work is typically carried out with different staining protocols and hence with a different colored effect of the cells. Should a non-stained sample to be examined be recorded, the latter can be selectively stained with different learnt color structures according to the invention, the color structures corresponding to the respective regional staining protocol. Firstly, this offers the advantage that the preferred or advantageous staining protocol can now be used for different pathologies. Secondly, this also allows the physician to consult another physician for their opinion since the first physician can show the second physician the image with the staining the latter is accustomed to. The digital staining allows the hurdles arising from the staining protocols to be circumvented because each physician can now choose their conventional staining for establishing findings. This would then also allow, e.g., physicians from Europe and the USA to cooperate better to the benefit of the patient. Consequently, this facilitates worldwide cooperation of the physicians and/or hematologists within the meaning of telemedicine.

Consequently, for telemedicine, or by way of telemedicine, the digitally suitably stained 3D images and/or data records allow any physician worldwide to contribute to the verified findings. Consequently, a reliably evaluated “ground truth” data record, which consists of a combination of image and/or 3D information and findings verified by at least two physicians, can advantageously arise, for example, by way of a database, in particular for rare pathological cases of observed and/or measured cells, by way of the worldwide link by means of telemedicine. An important component for this procedure also lies in the option according to the invention for being able to change the images in the focus in the digital data record, separately for each captured cell and in adapted fashion, without the physician making the findings themselves having to be seated in front of a microscope.

This data record, findings of which have been made by a plurality of physicians independently of one another, can then be used, providing there are corresponding findings, for, e.g., further training of computer models, the computer models then being restored on the devices installed worldwide in order thereby to develop each device in terms of the recognition quality for certain cells or in terms of the capability of being able to automatically identify specific pathologies.

Depending on the device, it may also be advantageous that analyzers according to the invention capture images and these images are then transferred, e.g., into cloud-based application or, more generally, to another computing unit, where the identification of cells, the segmentation thereof and an automated evaluation, e.g., within the meaning of an assignment to a class of cell type or findings as an identification of certain clinical pictures and/or the determination of a suspected certain clinical picture, then occur.

The physician has various options for displaying the image data, in respect of a cell, captured according to the invention.

Advantageously, use can be made of, e.g., a conventional 2D monitor, a mobile terminal, and/or a tablet PC. Advantageously, the color representation is balanced in such a way that the physician can assume a true-color color representation. This is particularly important in hematology because, particularly in the case of pathological or conspicuous cells, small color differences and structure differences in the image of the cell may provide an indication of an abnormality. Advantageously, the color reproduction, in particular in respect of a stable color reproduction, satisfies, e.g., the DICOM standard for medical devices (dicom.nema.org/).

Advantageously, the operator and/or user can then focus through the cell images and/or the planar image of the object carrier or of the flow cell by way of operating software. Advantageously, a correspondingly secure data link, or a data link meeting possible specifications, is available to the data on a local data memory, an overarching data memory, e.g., in a hospital, and/or a cloud. Preferably, the data can be made immediately accessible to a physician for, e.g., a consultative examination.

Preferably, a 3D-capable display is used, which can be looked at either with or, particularly preferably, without further optical aids and which generates a 3D visual impression for the user. Preferably, the 3D-capable display is part of a computer and/or a mobile terminal, e.g., a tablet. Preferably, the 3D effect can be activated and deactivated in this case.

Preferably, data goggles, also referred to as smart glasses or VR glasses, are used for the 3D representation of the data record.

Preferably, according to the invention, a master/slave work mode is provided for remote findings in telemedicine, if, when the image is diagnosed at the same time by a plurality of physicians, e.g., within the scope of medical conference, one of the physicians, acting as a master, leads the navigation of the images of the cells and/or of the object carrier and/or the flow cell, and the other physicians are able to follow this without independent control of the system.

Preferably, each of the physicians can also focus through their image independently of the other physicians and/or stain the image according to their accustomed staining protocol.

### LIST OF REFERENCE SIGNS

1 Microscope
2 Sample
3 Blood cell
4 Light source
6 Light beams
8 Light field camera
9 Color camera
10 Flow cell

1. An analyzer for analyzing a medical sample, the analyzer comprising:
an optical microscope for imaging a light field in an object region for the purposes of imaging the sample, the microscope comprising a light source for illuminating the sample and an objective lens comprising a converging lens for converging and focusing light beams emanating from the illuminated sample,
a digital recording device for recording the light beams, and
a light field camera provided on the microscope for capturing the light field from the object region imaged in the microscope.

2. The analyzer as claimed in claim 1, wherein the light field camera comprises a microlens array with lenses with different focal lengths, wherein the microlens array can image an intermediate image of the light field imaged in the microscope onto the digital recording device.

3. The analyzer as claimed in claim 1, wherein the analyzer is an automated hematology analyzer, and the sample is a blood sample comprising blood cells.

4. The analyzer as claimed in claim 1, wherein the microscope is an amplitude contrast microscope or a phase contrast microscope or a differential interference contrast (DIC) microscope.

5. The analyzer as claimed in claim 1, wherein a further camera for capturing an image in an object plane in the object region is provided on the microscope, wherein the further camera has a higher lateral resolution than a lateral resolution of the light field camera, wherein a resolution of the further camera is twice a resolution of the light field camera, and wherein the further camera has a larger field of view than the light field camera.

6. The analyzer as claimed in claim 5, wherein the further camera is a color camera.

7. The analyzer as claimed in claim 1, wherein an incoherent illumination Sigma is greater than 0.8 on the microscope, wherein the Sigma is given as a ratio of a numerical aperture of an illumination of the sample and a numerical aperture of the objective lens, and wherein the microscope is a differential interference contrast (DIC) microscope.

8. The analyzer as claimed in claim 1, wherein the analyzer comprises a flow cell for supplying the sample and wherein an object plane of the microscope lies in the flow cell.

9. A method for ascertaining two-dimensional or three-dimensional information about a cell or a medical preparation with an analyzer, the method comprising the steps of:
a) supplying a sample with the cell or the medical preparation to a microscope, the microscope for imaging a light field in an object region and comprising a light source and an objective lens,
b) recording light beams emanating from the cell or the medical preparation with a digital recording device in response to illuminating the sample with the light source,
c) imaging the light field imaged in the microscope from the object region with a light field camera,
d) ascertaining two-dimensional or three-dimensional or volumetric information about the cell or the medical preparation from information of the light beams recorded in step b) or information of the light field imaged in step c).

10. The method as claimed in claim 9, wherein the sample in step a) is supplied to the analyzer by way of a flow cell and wherein an object plane in the object region of the microscope lies in the flow cell, or wherein the sample in step a) is supplied to the analyzer on an object carrier by way of a sample supply appliance for object carriers.

11. The method as claimed in claim 9, wherein the cells or medical preparations are not stained.

12. The method as claimed in claim 9, further comprising the step of:
e) carrying out digital refocusing or a focus variation by way of the two dimensional or three-dimensional or volumetric information of the cell, ascertained in step d), along an optical axis of the microscope, wherein the digital refocusing is implemented in computer-assisted or numerical fashion.

13. The method as claimed in claim 9, further comprising the step of:
f) assigning the cell to a cell type based on predetermined information and the two-dimensional or three-dimensional or volumetric information about the cell ascertained in step d).

14. A method for assigning a cell to a cell type, comprising a method for ascertaining two-dimensional or three-dimensional or volumetric information about the cell as claimed in claim 13, wherein steps a) to d) are carried out at a first location and wherein the information ascertained in step d) is digitally transferred to a second location via a network connection and wherein step f) is performed at the second location.

15. A method for digitally staining a cell or a medical preparation, the method comprising the following steps:
a) supplying a sample with the cell or the medical preparation to a microscope, the microscope for imaging a light field in an object region and comprising a light source and an objective lens,
b) recording light beams emanating from the cell or the medical reparation with a digital recording device in response to illuminating the sample with the light source,
c) imaging the light field imaged in the microscope from the object region with a light field camera,
d) ascertaining two-dimensional or three-dimensional or volumetric information about the cell or the medical preparation from information of the light beams recorded in step b) or information of the light field imaged in step c),
e) digitally staining the cell or the medical preparation in accordance with a predetermined assignment between the two-dimensional or three-dimensional or volumetric information about the cell or the medical preparation and staining of a corresponding cell or medical preparation or a structure within the cell or the medical preparation by way of a staining protocol, and
f) displaying an image of the digitally stained cell or preparation.

16. The method as claimed in claim 15, wherein the staining protocol is the May-Grünwald-Giemsa staining protocol, modified Wright staining protocol, Wright-Giemsa staining protocol, or Romanowsky staining protocol.

17. The method as claimed in claim 15, further comprising the step of:
carrying out digital refocusing or a focus variation by way of the two-dimensional or three-dimensional or volumetric information of the cell, ascertained in step d), along an optical axis of the microscope, wherein the digital refocusing is implemented in computer assisted or numerical fashion.

18. The method as claimed in claim 15, further comprising the step of:
assigning the cell to a cell type based on predetermined information and the two-dimensional or three-dimensional or volumetric information about the cell ascertained in step d).

19. The analyzer as claimed in claim 6, wherein the resolution of the further camera is four times the resolution of the light field camera, or the further camera is a 3-chip color camera.

20. The analyzer as claimed in claim 7, wherein the incoherent illumination Sigma is equal to 1.0 on the microscope.
